(19) United States
(12) Patent Application Publication
(10) Pub. No.: US 2010/0039291 A1
(43) Pub. Date: Feb. 18, 2010

(54) Vehicle/Crosswalk Communication System

(76) Inventors: Michael A. Harrison, Santa Rosa, CA (US); Dave Michaelson, Santa Rosa, CA (US)

Correspondence Address: LARRY D. JOHNSON, P.O. BOX 470277, CELEBRATION, FL, 34747, US

(21) Appl. No.: 12/542,568

(22) Filed: Aug. 17, 2009

Related U.S. Application Data
(60) Provisional application No. 61/189,067, filed on Aug. 15, 2008.

(51) Int. Cl. G08G 1/095; G08G 1/00

(52) U.S. Cl. 340/928; 340/944

(57) ABSTRACT

A wireless communication system for and between a monitored (“smart”) pedestrian crosswalk and an approaching vehicle, alerting the operator of the vehicle to the presence of a pedestrian in the crosswalk. The invention uses wireless electronic communication for transmitting signals to vehicles or motorists equipped with a compatible receiver. The communication is then interpreted by the receiver to provide an “alert” (audible and/or visual) to the motorist.

### CROSS REFERENCE TO RELATED APPLICATIONS

The present application claims the benefit of the filing date of U.S. Provisional Patent Application Ser. No. 61/189,067, filed Aug. 15, 2008, and hereby incorporated by reference herein.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to traffic warning and control systems, and more particularly to an improved communication system enabling the wireless transmission of a signal from a pedestrian crosswalk to an approaching vehicle, alerting the operator of the vehicle to the presence of a pedestrian in the crosswalk.

### BACKGROUND INFORMATION AND DISCUSSION OF RELATED ART

U.S. Pat. No. 6,384,742 to Harrison discloses a traffic warning system which alerts approaching vehicle traffic to the presence of a pedestrian in a crosswalk. The system includes a plurality of surface mounted lights partially embedded in and placed across a roadway. The lights are activated by the pedestrian, either by manual switch or by a sensor, before he enters the crosswalk. Once activated, the flashing lights warn drivers of approaching vehicles that a pedestrian may have entered the crosswalk, and that caution should be exercised.

U.S. Pat. No. 6,597,293 to Harrison describes a traffic warning system which alerts approaching vehicle traffic to an intersection stop requirement. The system includes a plurality of above-pavement, surface mounted lights, installed in a fashion similar to currently used road reflectors, and which are partially embedded in a roadway and placed across the roadway, e.g., adjacent to and parallel with the existing stripes or stop bars designating an intersection, and constructed so that they are impervious to vehicle traffic over them. Once activated, the lights flash in the direction of oncoming traffic, and emanate directly from the roadway, to warn drivers of approaching vehicles that a stop may be required at the intersection, and that caution should be exercised.

U.S. Pat. No. 6,683,540 to Harrison teaches a traffic warning system which alerts approaching vehicle traffic to the approach of a train in a crossing. The system includes a plurality of surface mounted lights partially embedded in and placed across a roadway. Once activated, the flashing lights warn drivers of approaching vehicles that a train is approaching, and that caution should be exercised.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### SUMMARY OF THE INVENTION

The vehicle/crosswalk communication system of the present invention provides a wireless communication system for and between a monitored (“smart”) pedestrian crosswalk and an approaching vehicle, alerting the operator of the vehicle to the presence of a pedestrian in the crosswalk. The invention uses wireless electronic communication (radio frequency waves, e.g., HF, VHF, UHF, SHF, EHF, FM bands, AM bands, GPS band, cell phone band, etc.) for transmitting signals to vehicles or motorists equipped with a compatible receiver. The communication is then interpreted by the receiver to provide an “alert” (audible and/or visual) to the motorist.

When any monitored crosswalk system is activated (e.g., via manual activation by a pedestrian, via automatic activation by pedestrian detectors—infrared, motion detection, ultrasonic, pressure plate, microwave, video, etc., or via a scheduled event or time) a radio signal is transmitted by the system, either in the direction of traffic flow or omni-directional. The radio signal is preferably transmitted continuously or for the duration of the cross-time established by the system.

A compatible receiver (integrated into the vehicle, attached to the vehicle, or brought into the vehicle carried by the motorist or passengers) receives the radio signal. The receiver interprets the radio signal and then initiates an alert. Alerts can take the form of aural (e.g., beeping or voice, preferably over-riding other vehicle sounds by suppressing the radio, phone, GPS, etc.) and/or visual (e.g., images pop-up on a multi function display, flashing light, message on heads up display, etc.). The alert will continue or repeat for as long as it receives the transmitted radio signal.

The transmitted radio signal may contain any of the following information: encoding, clock time in fractions of a second, active crosswalk latitude, active crosswalk longitude, active crosswalk elevation, active crosswalk compass direction, and/or active crosswalk street name, etc. The compatible receiver may have an integral software application as part of a GPS unit, a cell phone, a radio, etc.

Different alerts may be used depending on the compass direction of the crosswalk and the approaching motorist to convey appropriate information to the motorist. Alerts will not be given if the vehicle is moving approximately away from the crosswalk (to minimize nuisance distraction). Vehicles approaching approximately perpendicular to the crosswalk compass direction may be provided with a different alert than vehicles approaching parallel to the crosswalk compass direction.

It is therefore an object of the present invention to provide a new and improved pedestrian crosswalk warning system.

It is another object of the present invention to provide a new and improved system enabling the wireless transmission of a signal from a pedestrian crosswalk to an approaching vehicle, alerting the operator of the vehicle to the presence of a pedestrian in the crosswalk.

A further object or feature of the present invention is a new and improved system to alert only approaching vehicles in the immediate vicinity of a crosswalk to the presence of a pedestrian in the crosswalk.

An even further object of the present invention is to provide a novel pedestrian crosswalk warning system that works in conjunction with existing GPS receivers.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a generalized block diagram of the vehicle/crosswalk communication system of this invention.

### DETAILED DESCRIPTION OF THE INVENTION

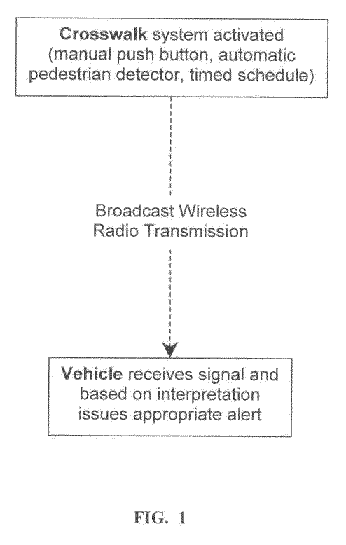

Referring to FIG. 1, there is illustrated therein a generalized block diagram of the vehicle/crosswalk communication system of this invention. First, the monitored crosswalk system is activated (as by push button or other manual activation by a pedestrian, by automatic activation by pedestrian detectors—infrared, motion detection, ultrasonic, pressure plate, microwave, video, etc., or by a scheduled event or time). Next, a radio signal is transmitted by the system, either in the direction of traffic flow or omni-directional, and preferably for the duration of the cross-time established by the system. A compatible receiver in the vehicle receives the radio signal, interprets the radio signal, and initiates an alert as appropriate and determined by the system.

The alert will continue or repeat for as long as it receives the transmitted radio signal.

The following are exemplary embodiments of the inventive system:

Transmission to Dedicated Receiver: When activated, the monitored crosswalk system transmits an encoded radio signal, preferably in a range of approximately 500 feet around the crosswalk. The encoded signal may repeat multiple times per second. Vehicles equipped with a compatible, dedicated receiver decode the radio signal and based on the “doppler” delay between received signals, internal software determines if the vehicle is approaching an active crosswalk, and then initiates an alert to the driver (visual and/or aural). Advantages of this embodiment include a relatively short range necessary for transmission; off-the-shelf technology; and the ability to add transmitters to legacy crosswalk systems. Disadvantages may include potential interference with other crosswalks in proximity; other radio interference (ambient to either the transmitter or receiver); and vehicles must be equipped with a dedicated receiver (either aftermarket OEM or by the vehicle manufacturer).

Transmission to Vehicle Radio: The monitored crosswalk system transmits an encoded radio signal on the standard FM and AM frequency bands, again preferably only up to a range of approximately 500 feet. Vehicles with a standard radio antenna and a dedicated decoder receive the encoded signal, and internal software determines if the vehicle is approaching an active crosswalk and then initiates an alert to the driver as described supra. Advantages of this embodiment include the radio wave infrastructure already in place for the “piggyback” of the signal; it can be integrated with existing SMART car radios; and it can be an add-on to a vehicle using an antenna splitter. Disadvantages may include the required license to use the frequency bands (all geographically local); vehicles must be equipped with customized receiver software the for system to work (either aftermarket OEM or by vehicle manufacturer); and the possible need to use different multiple frequencies depending on FAA regions and existing licenses.

Direct Transmission to GPS Receiver: The monitored crosswalk system transmits an encoded radio signal on the GPS frequency band. Again, the encoded signal preferably transmits only up to approximately 500 feet. Vehicles equipped with a GPS receiver then receive the encoded signal, and internal software determines if the vehicle is approaching an active crosswalk and initiates an alert to the driver as before. The dedicated software application, integrated into or interfacing with the GPS system, determines the relative bearing of the transmitted smart crosswalk signal relative to the vehicle's current direction vector. The vehicle's receiver should preferably either possess the ability to resolve directional ambiguity (e.g., be equipped with a 3D type of “volumetric” antenna array), or the transmitted signal would also have to communicate its latitude/longitude so that the dedicated software application can compute relative bearing. In terms of bearing, this would be the most important factor in determining whether to alert the motorist, as an alert would be an unnecessary nuisance to receding vehicles. Advantages to this embodiment include the GPS infrastructure already in place for this “piggyback” of signals. Disadvantages may include difficulty in receiving the GPS signals (line of sight type of reception); vehicles must be equipped with customized GPS software for the system to work (either aftermarket OEM or by vehicle manufacturer); and the need for compatibility with a variety of GPS systems.

Indirect Transmission to GPS Receiver (via Satellite): The monitored crosswalk system transmits an encoded radio signal to GPS satellites, which is then transmitted to earth. Vehicles equipped with GPS receive the encoded signal, and internal software determines if the vehicle is approaching an active crosswalk as before. Advantages to this embodiment include the GPS infrastructure already in place for this “piggyback” of signals. Disadvantages may include the transmission range of dozens of miles (possibly requiring a high power antenna array); integration and compatibility with existing and planned GPS navigation systems; and vehicles must be equipped with customized GPS software for the system to work (either aftermarket OEM or by vehicle manufacturer).

Transmission to Cell Phone: The monitored crosswalk system transmits an encoded radio signal on cell phone frequency bands. As before, the encoded signal preferably transmits only up to approximately 500 feet. Vehicles (or motorists) with cell phones receive the encoded signal, and internal software determines if the vehicle is approaching an active crosswalk and then initiates an alert to the driver as before. Advantages of this embodiment include the widespread use of cell phones; and no additional cost for consumers. Disadvantages include the possible difficulty of delivering encoded signals to cell phone “addresses;” the phone must be on and equipped with customized software (application) for the system to work; and the need for compatibility with a variety of cell phone systems.

Transmission to RFID-Equipped Vehicle: The monitored crosswalk system sends a signal (hard wired or wireless) to RFID transmission stations located along the roadway leading up to the crosswalk. The RFID stations then transmit an encoded alert signal (e.g., less than 25 feet) to the roadway. Vehicles equipped with an RFID (e.g. “FAST PASS”) device receive the signal and initiate an alert to the driver as before. Advantages to this embodiment include the RFID infrastructure already in place for this “piggyback” of signals. Disadvantages may include the necessity of several “powered” RFID stations along the route (due to the very short transmission range); and vehicles must be equipped with customized a RFID device for the system to work (either aftermarket or OEM).

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A vehicle/crosswalk communication system comprising:
a crosswalk monitor to detect presence of a pedestrian;
broadcast means to transmit a radio signal when said crosswalk monitor is activated;
a receiver in a vehicle, said receiver adapted to receive the transmitted signal;
receiver circuitry adapted to interpret the transmitted signal and determine if the vehicle is generally approaching the transmitted signal location; and
alarm means to alert the motorist that a pedestrian is crossing in the vicinity if the software determines that the vehicle is generally approaching the transmitted signal location.

2. The vehicle/crosswalk communication system of claim 1 wherein said crosswalk monitor is activated by a detector selected from the group consisting of push buttons, bollard pedestrian detectors, infrared detectors, motion sensors, microwave detectors, ultrasonic detectors, pressure plates, or video detectors.

3. The vehicle/crosswalk communication system of claim 1 wherein said radio signal is transmitted for the duration of the cross-time established by the system.

4. The vehicle/crosswalk communication system of claim 1 wherein said alarm means comprises an audible cue.

5. The vehicle/crosswalk communication system of claim 1 wherein said alarm means comprises a visual cue.

6. The vehicle/crosswalk communication system of claim 1 wherein said alarm means alerts the motorist for the duration of the transmission of the radio signal.

7. The vehicle/crosswalk communication system of claim 1 wherein said broadcast means comprises a radio transmitter, and said receiver comprises a dedicated radio receiver.

8. The vehicle/crosswalk communication system of claim 1 wherein said broadcast means comprises a radio transmitter, and said receiver comprises an AM/FM radio receiver.

9. The vehicle/crosswalk communication system of claim 1 wherein said broadcast means comprises a radio transmitter on a GPS frequency band, and said receiver comprises a GPS receiver.

10. The vehicle/crosswalk communication system of claim 1 wherein said broadcast means comprises a radio transmitting a signal to a GPS satellite, and said receiver comprises a GPS receiver receiving a signal from said GPS satellite.

11. The vehicle/crosswalk communication system of claim 1 wherein said broadcast means comprises a radio transmitter on a cell phone frequency band, and said receiver comprises a cell phone.

12. The vehicle/crosswalk communication system of claim 1 wherein said broadcast means comprises a radio transmitter on an RFID frequency band, and said receiver comprises an RFID receiver.
